(19) United States
(12) Patent Application Publication
(10) Pub. No.: US 2004/0122623 A1
(43) Pub. Date: Jun. 24, 2004

(54) Method and device for computer-aided analysis of a technical system

(75) Inventors: Wolfgang Gauckler, Kirchheim/Teck (DE); Herbert Gorl, Gemunden (DE); Werner Hoffmann, Herzogenaurach (DE); Gotz Kogel, Stuttgart (DE); Stepan Schischmanjan, Stuttgart (DE)

Correspondence Address: Henry M. Feiereisen, Suite 4714, 350 Fifth Avenue, New York, NY, 10118, US

(73) Assignee: SIEMENS AKTIENGESELLSCHAFT, Munchen (DE)

(21) Appl. No.: 10/692,346

(22) Filed: Oct. 23, 2003

(30) Foreign Application Priority Data
Oct. 23, 2002 (DE) 102 49 513.0
Sep. 18, 2003 (DE) 103 43 290.6

(51) Int. Cl. G06F 15/00

(52) U.S. Cl. 702/183

(57) ABSTRACT

A method and a device suitable for carrying out the method for analyzing technical system and/or machines and/or facilities is described. The device includes a database with a number of diagnoses. At least one attribute is associated with the diagnoses and at least one symptom description representing the technical system is associated with the attributes. An exception situation of the system is identified based on the attribute-related or symptom-related analysis of the diagnoses. Those diagnoses that are associated with the attribute and whose symptom description has a value that differs from an expected result, are evaluated and outputted. Based on an additional attribute, a particular diagnosis associated with the additional attribute is identified from the already identified diagnoses, whose symptom description has a value different from the expected result, and outputted.

### CROSS-REFERENCES TO RELATED APPLICATIONS

This application claims the priority of German Patent Applications, Serial Nos. 102 49 513.0, filed Oct. 23, 2002, and 103 43 290.6, filed Sep. 18, 2003, pursuant to 35 U.S.C. 119(a)-(d), the disclosure of which is incorporated herein by reference.

### BACKGROUND OF THE INVENTION

The present invention relates to a method and a device for computer-aided analysis of a technical system, e.g. a machine tool, e.g. a CNC machine, an electronic controller, in particular for interactively limiting possible diagnoses of an exception situation of a technical system by computer-aided investigation of individual symptoms for the exception situation.

The problem addressed by the invention is directed to finding causes of exception situations, for example faults, malfunctions and the like, of technical systems, for example machine-tools, based on a diagnostic knowledgebase derived from the system. The diagnosis knowledgebase for a technical system, a technical device, a machine, a facility and the like, hereinafter referred to summarily as technical system, must be easily expandable so that additional knowledge can be introduced without affecting the already existing knowledge in the knowledgebase.

Presents solutions for computer-aided diagnoses of technical systems are based essentially on two methodologies.

The first methodology uses a so-called fault tree approach, wherein a model for exception situations of a system is described in the form of fault trees. A fault tree is a representation of causes and/or symptoms of exception situations as well as mutual relationships in form of an abstract data type—a tree, also referred to as fault tree. Tree-like abstract data types are generally known. A fault tree, like other abstract data types with a tree structure, includes a number of nodes and links between each two nodes.

A single node is associated either with a sequence of commands or operating steps as well as a with final question, meaning an investigation, or with an analysis or diagnosis. Links describes the transitions between individual nodes, i.e. from a current node to another node (also referred to as daughter node). Fault trees can be systematically processed or traversed by executing the instructions or steps in a node and a corresponding specific investigation and then answering a final question. The respective response can lead to a daughter node or to an end. If the answer is a diagnosis, then this concludes the determination of the cause of the exception situation, i.e., the cause for the fault. Otherwise, the investigation is performed in conformance with the daughter node and a concluding question is again answered, etc. If the fault tree is finite, each time the fault tree is traversed the process must end at a node of the tree that does not have any other links, also referred to as a leaf of the fault tree. Such leaf is associated with a diagnosis (=the diagnosis for the actual exception situation of the system).

The second methodology is based on a determination of the relationships between malfunctions and the causes of these malfunctions (=malfunction-cause-relationships). The processing system accepts automatically or by user-entry messages of the investigated system and searches in databases for applicable causes for these malfunctions. These causes can be part of repair reports or service documents that are electronically displayed to the user.

Concepts and systems for addressing the aforedescribed problem, which are based on so-called artificial intelligence, have been developed in particular between 1982 and 1990. For example, Hernandez, Daniel: Wissensbasierte Diagnose technischer Systeme (Knowledge-based diagnosis of technical systems), Mitteilungsblatt des Regionalen Rechenzentrums Erlangen, Nr. 44, Erlangen, June 1986 or Pfeifer, Tilo; Richter, Michael M.: Diagnose von technischen Systemen (Diagnosis of technical systems), Deutscher Universitäts-Verlag, Wiesbaden 1993.

Disadvantageously, however, these conventional methodologies typically lack a globally linked diagnosis knowledgebase for complex technical systems of the aforedescribed type. Even if such knowledgebase were available, it may not be useful, because its complexity and the huge amount of data make visualization of the data impossible or at least difficult.

It would therefore be desirable and advantageous to provide an improved methodology for an automatic computer-aided analysis of a technical system, which obviates prior art shortcomings, as well as a device for carrying out the method.

### SUMMARY OF THE INVENTION

According to one aspect of the invention, a method for computer-aided analysis of a technical system with a database with a plurality of diagnoses includes the steps of associating at least one attribute with the plurality of diagnoses, associating at least one symptom description representing the technical system with the at least one of the attributes, and iteratively diagnosing an exception situation of the system by an attribute-related and/or symptom-related analysis of the plurality of diagnoses. The diagnoses are analyzed by—based an attribute—identifying and outputting those diagnoses associated with the attribute which have a symptom description with a value that is different from an expected result, and—based on an additional attribute—identifying and outputting from the identified diagnoses having a symptom description with a value that is a different from the expected result, the particular diagnosis that is associated with the additional attribute.

According to another aspect of the invention, a device for computer-aided analysis of a technical system includes means for storing a plurality of diagnoses having at least one attribute associated therewith, wherein at least one symptom description is associated with the at least one attribute, first program code means for iterative analysis of an exception situation of the technical system based on a symptom-related and/or or attribute-related analysis of a corresponding diagnosis, wherein based on the corresponding diagnosis an attribute representing the diagnosis and a symptom description of the attribute is determined and checked, and second program code means for generating an attribute list, wherein the corresponding attribute is transferred as a symptom into the attribute list if the attribute has a value different from an expected result.

Additional embodiments of the invention may include one or more of the following features.

The value of an attribute can be determined or entered by a user. Attributes having a symptom description with a value different from the expected result may be associated with a corresponding symptom, wherein the attributes identified as a symptom can be associated with and/or outputted in an attribute list. The attribute-related and/or symptom-related analysis of the plurality of diagnoses can be analyzed until for one diagnosis all attributes associated with the diagnosis have been identified in the attribute list for the exception situation.

If a value for a predetermined attribute deviates from the expected result, the diagnosis or each associated diagnosis is assigned to a suspect diagnostic list. An association function can be defined that describes the symptom description associated with the respective attribute. The association function can generate a truth value indicating if an attribute value is present as an element among a particular number of values representing the association function, or not.

The attributes of the attribute list identified as symptoms and/or the diagnoses of the suspect diagnostic list can be outputted in an order that corresponds to a predetermined or predeterminable rank or relevance. The diagnosis having the largest number of attributes identified as a symptom can be placed in the suspect diagnostic list with the higher rank, and vice versa.

According to another feature of the invention, the device can include third program code means for interactively outputting the attribute list, wherein the third program code means can evaluate the corresponding diagnosis based on attributes that have not been identified as a symptom. The device can further include fourth program code means for generating a suspect diagnostic list used in the attribute-related analysis of the corresponding diagnosis based on the at least one symptom description.

The invention is based on the observation that for each system a large number of analyses in form of diagnosis descriptions can be carried out or produced. An analysis of a technical system that can be applied in the context of the invention includes initially a diagnosis for the cause of a malfunction and one or more attributes representing the diagnosis, i.e., an attribute set. All technical data of the technical system can be regarded as attributes. The attributes can represent characteristic parameters, operating parameters, properties, such as pressure, flow rate, and/or an operating mode of a motor. The attributes are then analyzed, for example, based on input and/or output values, internal states, intermediate results, marker or register content and the like, as well as fault, warning or alarm messages and the like.

An attribute is an indication for a particular diagnosis if it satisfies certain predetermined conditions. The attribute is then referred to as symptom. A condition can be, for example, that a measured input value remains within a predefined (tolerance) range. Another condition can be that another measured value is always outside a predetermined range or below or above a limit or threshold value. Another condition can be that a certain warning, error or alarm message is present or not present. A further condition can be, that a predetermined condition of the aforedescribed kind is satisfied for a particular attribute or that another condition is not simultaneously satisfied for another attribute, etc. The conditions are preferably association functions such that the value of an attribute is either an element of a certain set or not an element of that set. An association function is also a function which provides as a result a so-called truth value, e.g. “YES”, “NO”; “TRUE”, “FALSE”, depending if a condition defined by the association function is satisfied or not. Such conditions, which can essentially have any complexity, will be combined hereinafter under the term Symptom Description.

Each symptom description can be individually formulated in the aforedescribed manner and can therefore take into consideration the respective relationships within the technical system as well as the interaction of the technical system with the environment, such as a controlled and/or monitored technical process.

This results in a plurality of diagnosis descriptions, wherein the plurality of diagnosis descriptions includes at least one diagnosis description. Each diagnosis description includes a diagnosis and an attribute set with at least one attribute. At least one symptom description is associated with each attribute.

An iterative computer-aided analysis or diagnosis is performed based on a simple database of this type, wherein an attribute representing a predefined or predefinable diagnosis (also referred to as a start attribute) and its symptom descriptions are determined and checked based on an attribute-related analysis. The corresponding start attribute based on its associated value, e.g. a measurement value (=actual value), is transferred as a symptom into an attribute list or symptom list, if the start value is different from an expected result, such as a reference value, and those diagnoses with which this attribute (=start attribute) is associated are identified.

Additional associated attributes are determined for the identified diagnoses and an attribute-related analysis is performed based on at least one of these attributes. In other words, it is checked for the additional attribute based on its symptom description if the value representing the attribute differs from the expected results. If this is the case, then the diagnosis associated with the attribute is identified from the identified diagnoses based on the attribute and optionally ranked depending on the magnitude of the deviation.

The diagnosis that may represent the primary cause for the exception situation can advantageously be determined by performing the attribute-related analysis of the identified diagnoses until the particular diagnosis is identified based on the attribute list of the exception situation for which all attributes associated with this diagnosis are identified as a symptom. Advantageously, the associated or underlying diagnosis for the corresponding attribute is associated with a suspect diagnostic list if the value deviates from an expected result. In other words, a list of suspect diagnoses is generated based on one or more attribute values of one or more diagnoses that deviate from a normal condition.

A suspect diagnosis is a diagnosis contained in the aforedescribed number of diagnosis descriptions, where the symptom description is satisfied for at least one attribute. Of equal importance is in this context the complementary situation, where the symptom description is not satisfied for at least one attribute. Critical is hereby the expression of the symptom description.

The attribute-related analysis preferably leads to a number of suspect diagnoses, whereby a single suspect diagnosis is sufficient to allow for an additional iterative computer-aided diagnosis. The plurality of the suspect diagnoses is referred to as a suspect diagnostic list.

In a subsequent method step, all attributes that are symptoms of the diagnoses determined to be suspect diagnoses and therefore satisfy the symptom description, are identified based on the suspect diagnostic list and optionally outputted. This results in a plurality of symptoms, wherein the plurality of symptoms includes at least one symptom. The plurality of symptoms is referred to as an attribute list.

In a subsequent process step, the attribute list sent to a user for evaluation/ranking. This display of the attribute list and evaluation/ranking is carried out in a known manner with conventional display and input means, for example as output on a display screen and/or input via a keyboard.

Particular symptoms can preferably be evaluated by associating an activation attribute with each symptom description. The activation attribute has the function of activating and deactivating an existing symptom. The activation attribute can be activated and deactivated automatically depending its type and function. For example, if the resulting value of a symptom deviates from a predetermined result, such as a reference or limit value, then the activation attribute can be activated, for example set. Conversely, if the value agrees with the value of the predetermined result, then the activation attribute is automatically deactivated, for example reset.

Alternatively or in addition, the activation attribute can also be manually activated or deactivated. For example, a user who views the display of the actual value for a particular attribute or symptom, e.g. a position measured by an absolute distance sensor or an incremental sensor, can determine based on his/her technical competence that although the symptom description is satisfied, for example a position outside a tolerance range, this position is not capable of causing the actually observed error. In other words, a user or operator can decide via an interactive input if a symptom description for the actual diagnosis should be effective or should no longer be effective. This can be accomplished by setting or resetting the activation attribute of the symptom description. A symptom description that includes a function expanded by an activation attribute can hence be summarized as follows: an attribute is a symptom of a diagnosis if at least the symptom description is satisfied and, optionally and in addition, the activation attribute is set. Each symptom description with its expanded functionality represents, for example, an AND-gate, whereby the output of the AND-gate can only be activated if the activation attribute is set.

By evaluating the individual symptoms of the attribute list, a user can successively exclude those symptoms which he may regard as unimportant in the context of the actual fault situation, based on his expertise. In other words: if a technical system exhibits significant fault function, e.g., a fire, a gas leak or the like, then it is inconsequential for this fault function if simultaneously another (less severe) fault occurs in the technical system, such as a malfunction of an instrument panel illumination or the like. Suspect diagnoses can exist for both exception situation which may have caused the associated symptom to be entered in the attribute list. When searching for the cause for a major fault function, the user will exclude those symptoms which appear to be unrelated to the major fault function, thereby reducing the size of the attribute list.

If particular symptoms are excluded by resetting the activation attribute, then the symptom description is no longer satisfied at the reset time, causing the symptom to be deleted from the attribute list. This reduces the number of symptoms contained in the attribute list.

According to an advantageous feature of the invention, the highly complex diagnosis knowledgebase is reduced to a quasi-one-dimensional structure, namely individual diagnoses with essentially the same weight. The attributes can be iteratively checked by a computer to ascertain that a symptom description is satisfied. The results can be presented to a user who can exclude specific suspect diagnoses by applying his expertise to the attribute-related analysis and thereby further reduce the set of the suspect diagnoses, until only a few diagnoses, in particular only one suspect diagnosis, remain(s), which is/are then identified as a diagnosis of the examined exception situation.

Advantageously, the attributes can be ordered, i.e. ranked, in the attribute list according to predetermined or predeterminable priorities. In this way, the attributes which have a particularly high relevance are evaluated first by the user.

Advantageously, interdependencies between, on one hand, diagnoses themselves and, on the other hand, between diagnoses and symptoms can also be determined and used for assigning priorities to the individual symptoms in the attribute list.

Advantageously, determined or established interdependencies between, on one hand, the diagnoses themselves and/or, on the other hand, the diagnoses and symptoms can be used to group or categorize the symptoms in the attribute list and/or the suspect diagnoses in the suspect diagnostic list. This allows to exclude systematically additional attributes from the attribute list if a specific attribute is excluded from the attribute list, whereby the attributes to be excluded are linked with the excluded symptom in that they have identical or sufficiently similar groups or categories. Such dependencies can be represented by a matrix of a type that is known, for example from graph theory, as weighting or distance matrix. Assuming that n symptoms exist in the attribute list, then a symmetric (n×n) matrix is obtained, wherein the numerical value at a matrix position p, q (with p=row index, q=column index) indicates the degree of dependency between the symptom p and the symptom q. The individual matrix positions can be suitably scaled numerically by having a value equal to or close to 1.0 indicate a significant dependency, i.e., a direct interaction, whereas larger values would indicate an increasingly reduced dependency. If there is definitively no dependency, then a sufficiently large value, for example “infinitely”, is assigned, represented, for example, by the value 0,0 expressing the corresponding symbol “∞” that cannot be displayed.

Other features of the invention relate to the construction of a diagnosis knowledgebase, i.e., the database forming the basis for the method of the invention. Particular diagnoses can be easily added to an existing database that already contains a plurality of diagnoses. This can be accomplished without affecting the existing knowledgebase, i.e. the already existing content of the database. If a custom-designed machine lacks, for example, a particular optional feature, then the diagnosis knowledgebase for this machine can be “filtered” from the knowledgebase of a machine that include the particular feature, by excluding or deleting all attributes and diagnoses that are associated with the option.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows an exemplary diagram for a diagnosis with attributes and symptoms of an exception situation of a technical system; and

FIG. 2 shows an exemplary diagram of an iterative method for analyzing the technical system, in particular for reducing a large number of possible suspect diagnoses to a simple suspect diagnosis.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

This is one of two applications both filed on the same day. Both applications deal with related inventions. They are commonly owned and have the same inventive entity. Both applications are unique, but incorporate the other by reference. Accordingly, the following U.S. patent application is hereby expressly incorporated by reference: “Method and Device for Automatic Association of Data Elements in Modeling of a Technical System”.

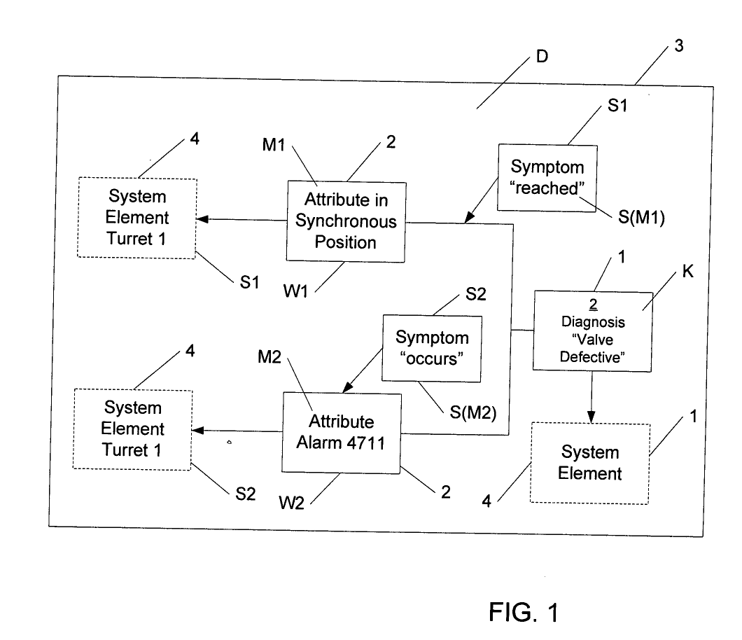

Turning now to the drawing, and in particular to FIG. 1, there is shown schematically a diagram of a diagnosis 1 for a technical system 2, e.g., for a valve with the diagnosis 1 “Valve Defective”. The term technical system 2 can refer to a simple electronic device, such as a controller or an electronic machine tool, or a complex technical system, such as a printing press. A number of diagnoses 1 is associated with the technical system 2 as analyses in the form of descriptions.

The diagnosis or each diagnosis 1 represents a dataset in a database D, which can be accessed for an iterative computer-aided diagnosis by program code means according to the invention (not shown). The database D is stored, for example, in the form of a database in a storage device 3, e.g. on a hard disk, a RAM or ROM memory, or a CD-ROM.

Each dataset in the database D, i.e. each diagnosis 1, includes, on one hand, the diagnosis 1 itself and, on the other hand, at least one attribute M1 that more closely describes the diagnosis 1. Due to the complexity of technical system 2, the diagnosis 1 includes a plurality of attributes M2 to Mz. The attributes M1 to Mz represent characteristic values, operating parameters and/or properties of the technical system 2. At least one symptom description S1 to Sz is associated with the attribute or with each attribute M1 to Mz. The symptom description S1 to Sz represents a fault or situation description for the associated attribute M1 to Mz.

In addition, a system element 4 for selecting or marking individual attributes M1 to Mz or complete datasets, i.e. complete diagnoses 1, is associated with each attribute M1 to Mz as well as with the diagnoses 1 of each data set as a first programming code means. For example, the system element 4 is a component, such as a personal computer, a handheld programming device, a display with a keyboard or another type of input and/or output unit, and/or a function, such as a diagnostic function.

A symptom description S1 to Sz is an association function with an associated truth value, such as [“YES”; “NO”], [“SATIFIED”; “NOT SATISFIED”] or [“TRUE”; “FALSE”], etc., depending on if the association function is satisfied or not. One of the illustrated attributes M1 to Mz can be an attribute M1 which, for example, describes an operating position of an exemplary technical system 2, such as a valve, expressed as an actual value or a value W1, e.g. an analog or digital measurement value. The actual value W1 of the attribute M1 is: “Attribute in Synchronous Position”, meaning that the component or valve is in a synchronous position. The associated symptom description S1 then checks if the component is actually in a synchronous position.

Based on the underlying association function of the symptom description S1 it is checked with a first program code means (not shown), if the actual value W1 of the attribute M1—the position value—has a value W1 that is different from the expected result Esoll. For example, it is checked if the actual value W1 deviates from the position expected from a synchronous position or from an expected position interval. If the obtained position value matches the position value expected at the synchronous position or if a position value is located inside an expected position interval, then the association function of the symptom description S1 provides a positive truth value, for example “YES”, “SATISFIED” or “TRUE”, etc. Otherwise, a negative truth value is obtained, for example “NO”, “NOT SATISFIED” or “FALSE”, etc. If a negative truth value is associated with the symptom description S1, then the associated attribute M1 is identified as symptom S(M1). In other words: a corresponding symptom S(1) to S(Mz) is associated with those attributes M1 to Mz whose symptom description S1 to Sz has a value W1 to Wz different from the expected result Esoll.

Another attribute from the illustrated attributes M1 to Mz may represent an attribute M2 with a value W2 that indicates the presence of a warning, a fault or an alarm message. The actual value W2 of the attribute M2 is: “Alarm 4711”, meaning an alarm message was generated. The associated symptom description S2 helps to determine if a warning, fault or alarm message exists. If an alarm message exists, the message “Symptom: Occurs” is outputted as a symptom description S2 and the corresponding attribute M2 is identified as symptom S(M2).

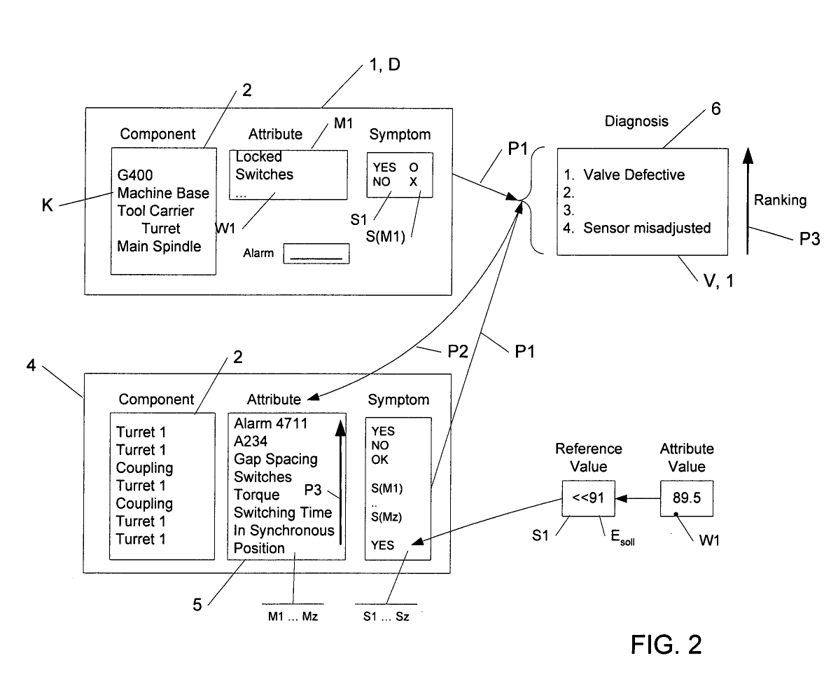

The evaluation of the diagnoses 1 of the database D is schematically depicted in FIG. 2. The diagram of FIG. 2 includes another representation of a diagnosis 1 in a form suitable for display to a user on a computer monitor. By evaluating the individual diagnoses 1 for the technical system 2, i.e. by checking the symptom description S1 to Sz of each attribute M1 to Mz of a diagnosis 1, a plurality of diagnoses 1 is obtained. Each attribute M1 to Mz represents an operating parameter, characteristic value or property of a associated component K of the technical system 2. Based on the symptom description S1 to Sz, the corresponding attribute M1 is activated as symptom S(M1) for at least one attribute M1 to Mz, if the value W1, e.g. an attribute value or an actual value, deviates from an expected result Esoll, for example a reference value, and outputted to an attribute list 5. Each such diagnosis 1, meaning the particular diagnosis 1 that has an attribute M1 to Mz with a value W1 to Wz that is different from an expected result Esoll, is marked as a suspect diagnosis V and optionally activated, evaluated and outputted.

The identified suspect diagnoses V are preferably generated in form of a suspect diagnostic list 6 and outputted. The suspect diagnostic list 6 is derived from the individual diagnoses 1 forming the database D (as indicated by the arrow P1 pointing from the diagnosis 1 to the suspect diagnostic list 6). The exemplary diagnoses 1 “Valve Defective” depicted in FIG. 1 is also part of the suspect diagnostic list 6, if one of the attributes M1 to Mz relating to this diagnosis 1 is identified as symptom S(M1) to S(Mz).

For the diagnoses 1 associated with the suspect diagnostic list 6 and the attributes M1 to Mz associated with the attribute list 5, a symptom suspicion for an additional attribute M1 to Mz is determined based on an additional attribute-related analysis, i.e. the additional attribute M1 to Mz is identified as symptom S(M1) to S(Mz) in the event of a deviation. All diagnoses 1 having this attribute M1 to Mz are subsequently outputted in the suspect diagnostic list 6. The number of diagnoses 1 in the suspect diagnostic list 6 can vary depending on the corresponding attribute M1 to Mz. In other words, it is determined based on an additional attribute-related analysis of the corresponding diagnoses 1 of the suspect diagnostic list 6 for additional attributes M1 to Mz of these diagnoses 1, if their associated symptom description S1 to Sz produces a (truth) value W1 to Wz that deviates from the expected result Esoll. These attributes M1 to Mz are referred to as symptoms S(M1) to S(Mz) and accordingly the number of the symptoms S(M1) to S(Mz), i.e., the additional list, is referred to as attribute list 5 in order to distinguish them from other attributes M1 to Mz. The arrow P2 between the suspect diagnostic list 6 and the attribute list 5 indicates that the attribute list 5 is derived from the suspect diagnostic list 6. This process—attribute-related analysis of the diagnoses 1 of the suspect diagnostic list 6—is performed until the attribute list 5 is reduced to a single attribute M1 to Mz as symptom S(M1) to S(Mz), or alternatively until the diagnosis 1 is identified in the suspect diagnostic list 6 for which all the corresponding attributes M1 to Mz are identified as symptoms S(M1) to S(Mz).

The vertically upward pointing arrow P3 indicates with respect to the suspect diagnostic list 6 and to the attribute list 5 that both lists 5, 6 are ordered according to a priority or a valence of the individual list elements, i.e. the suspect diagnoses V and/or the attributes M1 to Mz that have been identified as symptoms S(M1) to S(Mz). For example, the highest priority in the suspect diagnostic list 6 is assigned to the diagnosis 1 that has the largest number of attributes M1 to Mz that have been identified as symptoms S(M1) to S(Mz).

A user of the method can exclude particular diagnoses 1 and/or symptoms S(M1) to S(Mz) by way of the system element 4 in accordance with the determined order of the diagnoses 1 in the suspect diagnostic list 5 and optionally of the symptoms S(M1) to S(Mz) in the attribute list 5. Advantageously, several conventional visualizations and methods can be used, for example by opening a context menu or by “clicking” on the display, with FIG. 2 showing an example for a visualization on a display screen. A user can interactively monitor the process and enter data using a browser-supported user interface which can communicate with a server executing the computer-aided analysis of a technical system via a network, such as an intranet or the Internet.

The exclusion of specific diagnoses from the suspect diagnostic list 6 and/or of symptoms S(M1) to S(Mz) from the attribute list 5 is transparent to the user. In other words, when the user excludes a symptom S(M1) to S(Mz), an activation attribute (not shown), which is preferably associated with the symptom description S1 to Sz of the corresponding symptom S(M1) to S(Mz), is reset. When an activation attribute is reset, the monitoring function required for the symptom description S1 to Sz to determine if the value W1 to Wz deviates from the expected result Esoll is deactivated. In addition, the associated attribute Ml to Mz or the associated diagnosis are not transferred to the attribute list 5 or the suspect diagnostic list 6. When the activation attribute is reset, the corresponding symptom S(M1) to S(Mz) is automatically deleted from the attribute list 5, and the diagnoses 1 is reevaluated and reprioritized in the suspect diagnostic list 6.

The user can request that the actual value W1 to Wz of the corresponding attribute M1 to Mz be displayed for each attribute M1 to Mz (symptom) in order to exclude specific diagnoses 1 from the suspect diagnostic list 6 and/or specific symptoms S(M1) to S(Mz) from the attribute list 5. An exemplary value W1 “89.5” is displayed for the attribute M1 already listed in FIG. 1. In addition, the symptom description S1 is given for this attribute M1. Also shown is the underlying association function which performs a check relative to an expected result Esoll represented by a reference value, in this case “91”. An informed user can decide with relative certainty based on the determined value W1 as well as the symptom description S1, if the value W1 satisfies the conditions for the attribute M1 so as to be identified as symptom S(M1). If this is a case, then the diagnosis 1 is transferred to the suspect diagnostic list 6 and the symptom S(M1) is transferred to the attribute list 5 and outputted. Otherwise, the diagnosis 1 and the symptom S(M1) are deleted.

Particular diagnoses 1 can also be excluded from the suspect diagnostic list 6 and/or particular symptoms S(M1) to S(Mz) or a group of symptoms S(M1) to S(Mz) can be excluded from the attribute list 5 based on the system elements 4, with which the particular attributes M1 to Mz and/or symptoms S(M1) to S(Mz) are associated. For example, this is a case when the user based can decide on his expertise that a system element 4 has no effect on the observed exception situation, e.g. the observed malfunction of the technical system 2. The total number of symptoms S(M1) to S(Mz) which is associated with the corresponding system element 4, can then be deleted from the attribute list 5, or the underlying diagnosis 1 can be deleted from the suspect diagnostic list 6, so that the corresponding system element 4 is deactivated.

In addition, the diagnoses 1 of the database D can be processed by way of the system elements 4 prior to generating the suspect diagnostic list 6. The symptom description S1 to Sz does not have to be checked for those system elements 4 that exist in the database D, but not in the investigated technical system 2, for example because the system 2 lacks certain optional functionalities, since the associated diagnosis 1 is never considered to be a suspect diagnosis V.

In practice, the method is implemented in software, whereby the software can be embodied in different ways, which can also include so-called firmware, or the functionality of the software can be implemented in form of ASICs and the like. The extensive software can be subdivided into individual, functionally associated segments. Such segments are referred to, for example, as modules, functions, procedures, routines and the like. The totality of these segments will be referred to as program code means.

A device for carrying out the method of the invention (not shown) therefore includes means for storing a plurality of diagnoses 1 having at least one attribute M1 to Mz associated therewith, whereby at least one symptom description S1 to Sz is associated with the attribute M1 to Mz or with each attribute M1 to Mz. In addition, the device includes a memory embodied as a semiconductor memory (main memory, RAM) or as an external memory (hard disk and the like), first program code means embodied as a corresponding software module, a subprogram and the like, for evaluating all or selected symptom descriptions S1 to Sz of the stored diagnoses 1, second program code means, i.e. a corresponding second software module, subprogram and the like, for establishing an attribute list 5 for processing the symptom descriptions S1 to Sz, and third program code means, i.e. yet another software module, subprogram and the like, for outputting the content of the attribute list 5 to a user of the device.

The preceding description applies also to a device suitable for carrying out all the embodiments of the method, whereby the device may include additional program code means for enhancing its functionality.

The invention can be summarized as follows:

A method and a device suitable for carrying out the method for analyzing technical devices and/or machines and/or facilities is described. The device includes a database D with data sets in the form of diagnoses 1 having at least one attribute M1 to Mz and its associated operating parameter, i.e. a value W1 to Wz. At least one symptom description S1 to Sz is associated with each attribute M1 to Mz. All or selected symptom descriptions S1 to Sz are evaluated and, depending on the outcome of the evaluation, those attributes M1 to Mz that have a value W1 to Wz identified as a symptom S(M1) to S(Mz) are transferred to an attribute list 5. The attribute list 5 is displayed, e.g. on a monitor, for further processing by the user.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

What is claimed is:

1. A method for computer-aided analysis of a technical system which includes a database with a plurality of diagnoses, comprising the steps of:
associating at least one attribute with the plurality of diagnoses,
associating at least one symptom description representing the technical system with the at least one of the attributes, and
iteratively diagnosing an exception situation of the system by an attribute-related and/or symptom-related analysis of the plurality of diagnoses by
based the at least one attribute—identifying and outputting those diagnoses associated with the attribute which have a symptom description with a value that is different from an expected result, and
based on an additional attribute—identifying and outputting from the identified diagnoses having a symptom description with a value that is a different from the expected result, the diagnosis associated with the additional attribute.

2. The method of claim 1, wherein the attributes having a symptom description with a value different from the expected result are associated with a corresponding symptom.

3. The method of claim 1, wherein the attributes identified as a symptom are associated with and/or outputted in an attribute list.

4. The method of claim 3, wherein the step of performing the attribute-related and/or symptom-related analysis of the plurality of diagnoses is executed until for one diagnosis all attributes associated with the diagnosis have been identified as a symptom in the attribute list for the exception situation.

5. The method of claim 1, wherein, if a value for a predetermined attribute deviates from the expected result, the diagnosis or each associated diagnosis is assigned to a suspect diagnostic list.

6. The method of claim 1, and further including the step of defining an association function that describes the symptom description associated with the respective attribute, said association function generating a truth value indicating if an attribute value is present as an element among a particular number of values representing the association function, or not.

7. The method of claim 1, wherein the value of an attribute is determined or entered by a user.

8. The method of claim 3, wherein, if a value for a predetermined attribute deviates from the expected result, the diagnosis or each associated diagnosis is assigned to a suspect diagnostic list, and wherein the attributes of the attribute list identified as symptoms and/or the diagnoses of the suspect diagnostic list are outputted in an order that corresponds to a predetermined or predeterminable rank or relevance.

9. The method of claim 8, wherein the diagnosis having the largest number of attributes identified as a symptom is placed in the suspect diagnostic list with the higher rank, and vice versa.

10. A device for computer-aided analysis of a technical system, comprising:
at least one means for storing a plurality of diagnoses having at least one attribute associated therewith, wherein at least one symptom description is associated with the at least one attribute,
first program code means for iterative analysis of an exception situation of the technical system based on a symptom-related and/or or attribute-related analysis of a corresponding diagnosis, wherein based on the corresponding diagnosis an attribute representing the diagnosis and a symptom description of the attribute is determined and checked, and
second program code means for generating an attribute list, wherein the corresponding attribute is transferred as a symptom into the attribute list if the attribute has a value different from an expected result.

11. The device of claim 10, further comprising third program code means for interactively outputting the attribute list, said third program code means capable of evaluating the corresponding diagnosis based on attributes that have not been identified as a symptom.

12. The device of claim 10, further comprising fourth program code means for generating a suspect diagnostic list used in the attribute-related analysis of the corresponding diagnosis based on the at least one symptom description.
